(19) United States
(12) Patent Application Publication
(10) Pub. No.: US 2025/0376097 A1
(43) Pub. Date: Dec. 11, 2025

(54) SEAT AND METHOD OF ADJUSTING A SIZE AND COMFORT OF THE SEAT

(71) Applicant: GM GLOBAL TECHNOLOGY OPERATIONS LLC, Detroit, MI (US)

(72) Inventors: Edward T. Kuczynski, Bloomfield Hills, MI (US); Daniel J. Ridgeway, Grosse Pointe Park, MI (US); Bonita J. Thomas, Linden, MI (US); Jill M. Green, Highland, MI (US); Matthew R. Cwynar, Pinckney, MI (US); Matthew Isakson, Royal Oak, MI (US); Lindsay J. Nault, Berkley, MI (US); Marielle L. Day, Milford, MI (US); Victoria F. Streberger, Bruce Twp., MI (US)

(73) Assignee: GM GLOBAL TECHNOLOGY OPERATIONS LLC, Detroit, MI (US)

(21) Appl. No.: 18/735,730

(22) Filed: Jun. 6, 2024

(51) Int. Cl. B60N 2/90; B60N 2/66; B60N 2/70

(52) U.S. Cl. CPC B60N 2/976; B60N 2/665; B60N 2/7088; B60N 2/914; B60N 2/99

(57) ABSTRACT

A seat includes a seat frame, a seating surface supported by the seat frame, and a comfort system disposed between the seat frame and seating surface. The comfort system includes a bladder transitionable between an inflated condition and a deflated condition such that the bladder has a variable size and a variable firmness. The bladder defines a cavity and includes a lower surface adjacent the seat frame, and an upper surface opposite the lower surface and configured to support an occupant of the seat. The comfort system also includes a foam disposed within the cavity, wherein the foam contacts the upper surface when the bladder is in the deflated condition. The comfort system also includes a pump configured for alternately introducing air into the cavity and throughout the foam and removing air from the cavity and the foam to transition the bladder between the inflated condition and the deflated condition.

### INTRODUCTION

The disclosure relates to a seat and a method of adjusting a size and comfort of the seat.

Seats designed to accommodate occupants of vehicles, such as automotive seats, aviation seats, and the like are an essential component of a vehicle's interior and provide comfort and support for occupants during travel. A seat may include a seat cushion that forms a portion of a seating system. The seat cushion may be formed from foam or other cushioning materials, may optionally include bolsters, and may be covered with upholstery. Further, the seat may include a seat back that forms another portion of the seating system. The seat back may also be formed from foam or other cushioning materials, may optionally include bolsters, and may likewise be covered with upholstery. Such bolsters and layers of cushioning materials may be of fixed size and shape and may contribute to a comfort level of the seat.

### SUMMARY

A seat includes a seat frame, a seating surface supported by the seat frame, and a comfort system disposed between the seat frame and the seating surface. The comfort system includes a bladder transitionable between an inflated condition and a deflated condition such that the bladder has a variable size and a variable firmness. The bladder defines a cavity and includes a lower surface disposed adjacent the seat frame and an upper surface opposite the lower surface and configured to support an occupant of the seat. The comfort system also includes a foam disposed within the cavity, wherein the foam contacts the upper surface when the bladder is in the deflated condition, and a pump configured for alternately introducing air into the cavity and throughout the foam and removing air from the cavity and the foam to transition the bladder between the inflated condition and the deflated condition.

In one aspect, the bladder may have a first firmness when the cavity is open to airflow and has a second firmness that is greater than the first firmness when the cavity is closed to airflow.

In an additional aspect, the bladder may have a first size when the bladder is in the deflated condition, and the bladder may have a second size that is greater than the first size when the bladder is in the inflated condition.

In another aspect, the bladder may further define an opening therein configured for introducing air to and releasing air from the cavity.

In a further aspect, the comfort system may further include an airflow meter disposed between the bladder and the pump and configured for measuring a flowrate of air between the pump and the cavity.

In one aspect, the comfort system may further include a valve disposed between the airflow meter and the pump and configured for restricting airflow between the pump and the cavity.

In an additional aspect, the seating surface may include a seat cushion having a first longitudinal axis and a seat back attached to the seat cushion and having a second longitudinal axis laterally aligned with the first longitudinal axis along a third axis that intersects the first longitudinal axis and the second longitudinal axis.

In another aspect, the seat back may be pivotable about the third axis and may be configured to support a back of the occupant.

In a further aspect, the comfort system may include a plurality of bladders disposed beneath the seat cushion and the seat back and adjacent the seat frame, and each of the plurality of bladders may be individually controlled and individually transitionable between the inflated condition and the deflated condition.

In one aspect, at least some of the plurality of bladders may cyclically transition between the inflated condition and the deflated condition to thereby massage the occupant.

In an additional aspect, two of the plurality of bladders disposed beneath the seat back may be disposed on opposite sides of the first longitudinal axis, may be disposed adjacent the third axis, and may be configured to inflate to thereby provide lumbar support to the occupant.

In another aspect, each of the two of the plurality of bladders may cyclically transition between the inflated condition and the deflated condition to thereby massage the occupant.

In a further aspect, two of the plurality of bladders disposed beneath the seat back may be disposed on opposite sides of the first longitudinal axis, may be spaced apart from the third axis, and may be configured to inflate to thereby provide upper back support to the occupant.

In one aspect, the seat back may further include two side bolsters each disposed on opposite sides of the first longitudinal axis. At least one of the plurality of bladders may be disposed between one of the two side bolsters and the first longitudinal axis. Each of another two of the plurality of bladders may be disposed beneath a respective one of the two side bolsters adjacent the seat frame and may be transitionable between the inflated condition and the deflated condition to thereby adjust a comfort and size of the two side bolsters.

In an additional aspect, the seat cushion may further include two leg bolsters each disposed on opposite sides of the second longitudinal axis. At least one of the plurality of bladders may be disposed between one of the two leg bolsters and the second longitudinal axis. Each of another two of the plurality of bladders may be disposed beneath a respective one of the two leg bolsters adjacent the seat frame and may be transitionable between the inflated condition and the deflated condition to thereby adjust a comfort and size of the two leg bolsters.

In another aspect, the plurality of bladders disposed beneath the seat cushion may be configured to detect at least one of the occupant and an object disposed on the comfort system.

In a further aspect, the seat may further include a pressure sensor disposed within the cavity of at least one of the plurality of bladders and configured to detect a pressure exerted by the at least one of the occupant and the object on the comfort system.

In one aspect, the foam is an open-cell flexible polyurethane foam and the bladder may be formed from an elastomeric thermoplastic polyurethane.

In an additional aspect, a motor vehicle may include including the seat.

In one embodiment, the seat includes a seat frame and a seating surface supported by the seat frame. The seating surface includes a seat cushion having a first longitudinal axis, and a seat back attached to the seat cushion and having a second longitudinal axis laterally aligned with the first longitudinal axis along a third axis that intersects the first longitudinal axis and the second longitudinal axis. The seat back is pivotable about the third axis and includes two peripheral edges spaced apart from one another across the first longitudinal axis, a lower end adjacent the third axis, and an upper end spaced apart from the lower end along the first longitudinal axis. The seat back includes two side bolsters each disposed along a respective one of the two peripheral edges. The seat cushion includes two lateral edges spaced apart from one another across the second longitudinal axis and two leg bolsters each disposed along a respective one of the two lateral edges. The seat also includes a comfort system disposed between the seat frame and the seating surface. The comfort system includes a plurality of bladders disposed in a first symmetrical matrix on the seat back about the first longitudinal axis, disposed in a second symmetrical matrix on the seat cushion about the second longitudinal axis, and each transitionable between an inflated condition and a deflated condition such that each of the plurality of bladders has a variable size and a variable firmness. Each of the plurality of bladders defines a cavity and includes a lower surface disposed adjacent the seat frame, and an upper surface opposite the lower surface and configured to support an occupant of the seat. The comfort system also includes a foam disposed within the cavity of each of the plurality of bladders. The foam contacts the respective upper surface of each of the plurality of bladders when each of the plurality of bladders is in the deflated condition. The comfort system further includes a pump configured for alternately introducing air into the cavity of each of the plurality of bladders and throughout the foam and removing air from the cavity of each of the plurality of bladders and the foam to transition each of the plurality of bladders between the inflated condition and the deflated condition. In addition, the comfort system includes an airflow meter configured for measuring a flowrate of air between the pump and the foam, and a valve configured for restricting airflow between the pump and the foam. At least some of the plurality of bladders cyclically transition between the inflated condition and the deflated condition to massage the occupant. Two of the plurality of bladders disposed beneath the seat back are disposed on opposite sides of the first longitudinal axis between the two side bolsters at the lower end and are configured to inflate to provide lumbar support to the occupant. Two of the plurality of bladders disposed beneath the seat back are each disposed beneath a respective one of the two side bolsters adjacent the seat frame and are configured to adjust a dimension and firmness of the two side bolsters. Two of the plurality of bladders disposed beneath the seat cushion are each disposed beneath a respective one of the two leg bolsters adjacent the seat frame and are configured to adjust a dimension and firmness of the two leg bolsters. At least some of the plurality of bladders disposed beneath the seat cushion are configured to detect at least one of the occupant and an object disposed on the comfort system.

A method of adjusting a size and comfort of a seat includes regulating air contained within a comfort system disposed between a seat frame of the seat and a seating surface supported by the seat frame. The comfort system includes a bladder that is transitionable between an inflated condition and a deflated condition such that the bladder has a variable size and a variable firmness. The bladder defines a cavity and includes a lower surface disposed adjacent the seat frame, and an upper surface opposite the lower surface and configured to support an occupant of the seat. The comfort system also includes a foam disposed within the cavity, wherein the foam contacts the upper surface when the bladder is in the deflated condition. In addition, the comfort system includes a pump configured for alternately introducing air into the cavity and throughout the foam and removing air from the cavity and the foam to transition the bladder between the inflated condition and the deflated condition. The method also includes removing air from the cavity and the foam to transition the bladder to the deflated condition such that the foam contacts the upper surface of the bladder to thereby increase the size of the seat. The method further includes introducing the air into the cavity and throughout the foam to transition the bladder to the inflated condition to thereby decrease the size of the seat. In addition, the method includes opening the bladder to airflow to thereby decrease a firmness and adjust the comfort of the seat, and closing the bladder to airflow to thereby increase the firmness and adjust the comfort of the seat.

In one aspect, the method may further include at least one of massaging the occupant by cyclically inflating and deflating the bladder; providing lumbar support to the occupant by inflating the bladder; customizing at least one of two side bolsters and two leg bolsters of the seat by inflating or deflating the bladder; and detecting at least one of the occupant and an object disposed on the seat by sensing a pressure exerted on the bladder.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is a schematic plan view of a seat including a comfort system for adjusting a size and comfort of the seat.

FIG. 2 is a schematic side view of a vehicle including the seat and comfort system of FIG. 1.

FIG. 3 is a schematic illustration of a portion of the comfort system of FIG. 1.

FIG. 4 is a schematic flow diagram of a method of adjusting the size and comfort of the seat of FIGS. 1 and 2.

### DETAILED DESCRIPTION

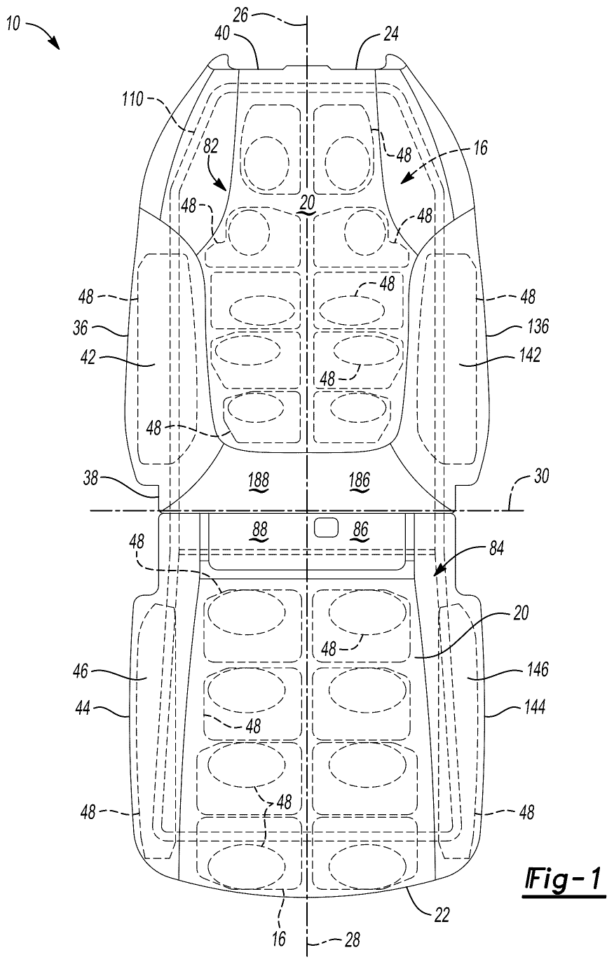

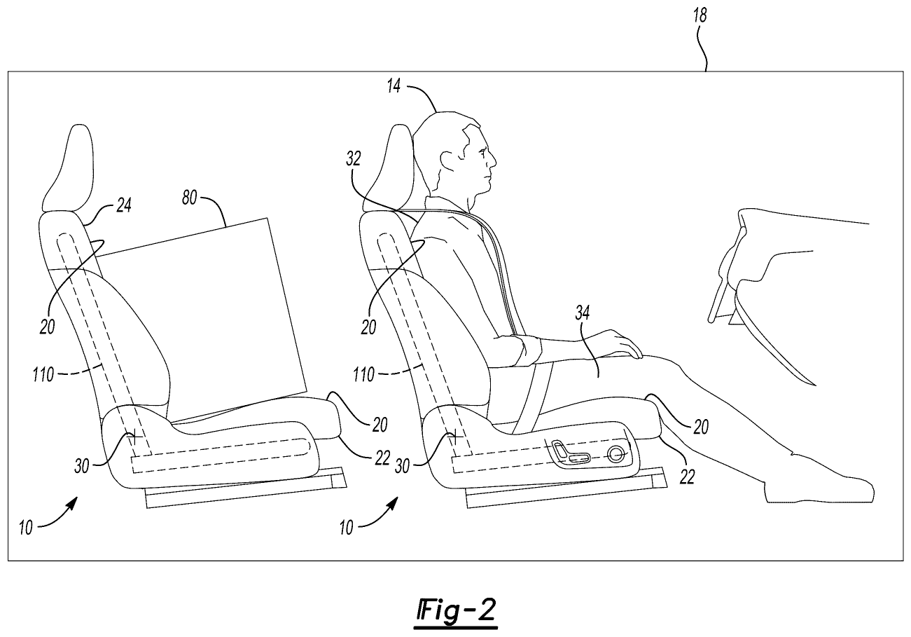

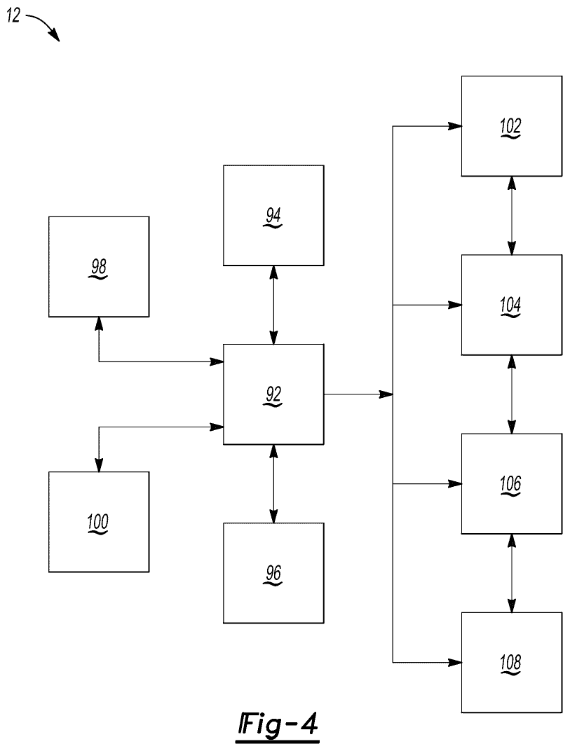

Referring to the Figures, wherein like reference numerals refer to like elements, a seat 10 (FIGS. 1 and 2) and method 12 (FIG. 4) of adjusting a size and comfort of the seat 10 are shown generally. The seat 10 and method 12 may be useful for applications requiring adjustable and comfortable seating for an occupant 14 (FIG. 2). In particular, the seat 10 and method 12 may be useful for adjusting a size, firmness, and comfort level of a vehicular seat 10 based on a shape, size, and/or preference of the occupant 14 to thereby reduce fatigue and enhance comfort of the occupant 14.

More specifically, as shown in FIG. 1, the seat 10 includes a comfort system 16 useful for adjusting the dimensions and comfort of the seat 10 according to varying occupant 14 sizes, shapes, structural differences, and preferences. As set forth in more detail below, the comfort system 16 provides adjustable firmness seat padding via contained air regulation, while also providing massage, lumbar support, bolster adjustability, and occupant detection functionality for the seat 10.

Therefore, the seat 10, comfort system 16, and method 12 may be useful for automotive applications such as, but not limited to, passenger seats and driver seats. For example, a motor vehicle 18 (FIG. 2) may include the seat 10 and comfort system 16. Alternatively, the seat 10, comfort system 16, and method 12 may be useful for non-automotive applications such as, but not limited to, aerospace, aviation, marine, mass transportation, agricultural, industrial, and rail applications.

Referring now to FIGS. 1 and 2, the seat 10 includes a seat frame 110 and a seating surface 20 supported by the seat frame 110. The seat frame 110 may be a structural base of the seat 10, may be formed from metal, and may provide mounting points for other components of the seat 10. The seating surface 20 may be mounted or attached to and supported by the seat frame 110 and may in turn support the seated occupant 14. In particular, the seating surface 20 may include a seat cushion 22 and a seat back 24 attached to the seat cushion 22.

As best shown in FIG. 1, the seat cushion 22 may have a first longitudinal axis 26. The seat back 24 may have a second longitudinal axis 28 laterally aligned with the first longitudinal axis 26 along a third axis 30 that intersects the first longitudinal axis 26 and the second longitudinal axis 28. The seat back 24 may be pivotable about the third axis 30 and may be configured to support a back 32 (FIG. 2) of the occupant 14, whereas the seat cushion 22 may be configured to support the legs 34 (FIG. 2) of the occupant 14.

With continued reference to FIG. 1, in one embodiment, the seat back 24 includes two peripheral edges 36, 136 spaced apart from one another across the first longitudinal axis 26, a lower end 38 adjacent the third axis 30, and an upper end 40 spaced apart from the lower end 38 along the first longitudinal axis 26. The seat back 24 also includes two side bolsters 42, 142 each disposed along a respective one of the two peripheral edges 36, 136. Further, the seat cushion 22 includes two lateral edges 44, 144 spaced apart from one another across the second longitudinal axis 28. The seat cushion 22 also includes two leg bolsters 46, 146 each disposed along a respective one of the two lateral edges 44, 144.

Referring now to FIG. 1, the seat 10 includes a comfort system 16 disposed between the seat frame 110 and the seating surface 20. That is, the comfort system 16 may be disposed below or beneath the seating surface 20, which may be covered by a finish trim layer, such as an upholstery layer, for example. Therefore, a construction of the seat 10 may include a seat frame 110—comfort system 16—seating surface 20 arrangement, and the occupant 14 may sit on or be supported by the seating surface 20.

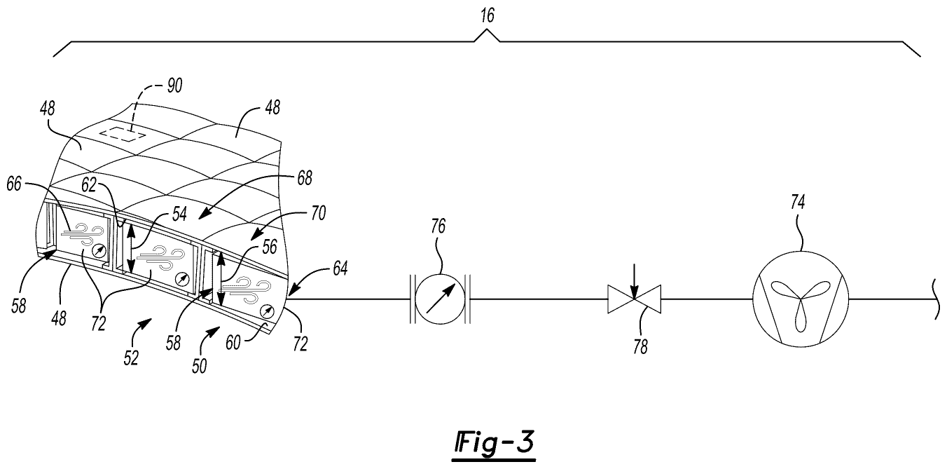

As set forth in more detail below, the comfort system 16 allows the occupant 14 to change the size and comfort of the seat 10. More specifically, as best shown in FIG. 3, the comfort system 16 includes a bladder 48 transitionable between an inflated condition 50 and a deflated condition 52 such that the bladder 48 has a variable size and a variable firmness. That is, the bladder 48 may have a first size 54 (FIG. 3) when the bladder 48 is in the deflated condition 52 and a second size 56 (FIG. 3) that is greater than the first size 54 when the bladder 48 is in the inflated condition 50.

As described with continued reference to FIG. 3, the bladder 48 defines a cavity 58 and includes a lower surface 60 disposed adjacent the seat frame 110 (FIG. 2) and an upper surface 62 opposite the lower surface 60 and configured to support the occupant 14 (FIG. 2). That is, the lower surface 60 may face the seat frame 110 and the upper surface 62 may face the seating surface 20. The bladder 48 may further define an opening 64 therein that is configured for introducing 96 (FIG. 4) air (denoted generally at 66 in FIG. 3) to the cavity 58 and releasing air 66 from the cavity 58. The bladder 48 may have a first firmness 68 when the cavity 58 is open to airflow and may have a second firmness 70 that is greater than the first firmness 68 when the cavity 58 is closed to airflow. In one non-limiting example, the bladder 48 may be configured as a skin and may be formed from an elastomeric thermoplastic polyurethane.

With continued reference to FIG. 3, the comfort system 16 also includes a foam 72 disposed within the cavity 58. The foam 72 may be relatively soft and resilient and may have a firmness that is comparatively less than a firmness of traditional comfort foam or seat padding. The foam 72 contacts the upper surface 62 of the bladder 48 when the bladder 48 is in the deflated condition 52 and may fill a portion or a majority of the cavity 58. Therefore, when an occupant 14 is seated on the comfort system 16 and the bladder 48 is in the deflated condition 52, the bladder 48 may not collapse upon itself. Rather, the foam 72 may support the occupant 14 on the seat 10. In one non-limiting example, the foam 72 may be an open-cell flexible polyurethane foam so that air 66 may flow within and between cells of the foam 72 and the foam 72 may flexibly compress and substantially recover its shape after compression.

Referring again to FIG. 3, the comfort system 16 further includes a pump 74 configured for alternately introducing 96 (FIG. 4) air 66 into the cavity 58 and throughout the foam 72 and removing 94 (FIG. 4) air 66 from the cavity 58 and the foam 72 to transition the bladder 48 between the inflated condition 50 and the deflated condition 52. For example, to transition the bladder 48 from the deflated condition 52 to the inflated condition 50, the pump 74 may be configured to operate as a blower and fill the cavity 58 and foam 72 with air 66. Conversely, to transition the bladder 48 from the inflated condition 50 to the deflated condition 52, the pump 74 may be configured to operate as a vacuum and remove air 66 from the cavity 58 and foam 72.

With continued reference to FIG. 3, in one embodiment, the comfort system 16 may further include an airflow meter 76 disposed between the bladder 48 and the pump 74 and configured for measuring a flowrate of air 66 between the pump 74 and the cavity 58. The comfort system 16 may also include a valve 78 disposed between the airflow meter 76 and the pump 74 and configured for restricting airflow between the pump 74 and the cavity 58. That is, the valve 78 may regulate airflow, may open to allow airflow to the cavity 58, and may partially or fully close to restrict airflow to the cavity 58.

Therefore, in operation, the comfort system 16 may function as adjustable firmness seat padding and enhance the adjustability and comfort of the seat 10. That is, with respect to a variable firmness or comfort adjustability of the seat 10, when the bladder 48 is open to natural airflow, the bladder 48 may be comparatively soft and equal in firmness to a firmness of the foam 72 disposed within the cavity 58. Stated differently, since the foam 72 is disposed within the cavity 58 and contacts the upper surface 62 of the bladder 48 even when the bladder 48 is deflated, the foam 72-filled bladder 48 may provide nominal static support to the occupant 14 even when the pump 74 is not introducing 96 air 66 to or removing 94 air 66 from the bladder 48.

Conversely, when the bladder 48 and foam 72 are closed to airflow, the comfort system 16 may be comparatively firm from the air 66 contained within the cavity 58 and foam 72. In particular, the comfort system 16 may provide support to the occupant 14 that is equivalent to a traditional foam pad or other layers of cushioning materials disposed beneath the occupant 14. However, the comfort system 16 may provide support to the occupant 14 without the use of traditional foam pads or other layers of cushioning materials situated underneath a layer of upholstery of the seat 10.

With respect to a variable dimension or size adjustability of the seat 10, the comfort system 16 may optimize a fit of the occupant 14 on the seat 10 regardless of a size or shape of the occupant 14. More specifically, the comfort system 16 may optimize the fit by regulating the air 66 contained within the foam 72-filled bladder 48. Such regulation of the air 66 contained within the foam 72-filled bladder 48 may include allowing natural airflow through the opening 64 defined by the bladder 48 that is restricted solely by the pneumatics of the foam 72, or by inflating and deflating the bladder 48 and foam 72 with the pump 74, e.g., when operating in blower or vacuum mode.

That is, when the bladder 48 and cavity 58 are open to natural airflow, or when the pump 74 is configured as a blower and introduces air 66 into the cavity 58 and foam 72 so that the bladder 48 is disposed in the inflated condition 50 (FIG. 3), the bladder 48 is at a maximum height or size, i.e., the second dimension or size 56 (FIG. 3) that is greater than the first dimension or size 54 (FIG. 3). However, when the pump 74 is configured to operate as a vacuum and fully or partially removes air 66 from the cavity 58 and foam 72, the bladder 48 and contained foam 72 are compressed to a desired height or thickness to thereby adjust the dimensions of the comfort system 16 and seat 10.

For example, while the pump 74 operates as a blower to introduce air 66 into the cavity 58 and throughout the foam 72, the pump 74 may inflate the bladder 48 to counteract compression of the bladder 48 and seat cushion 22 caused by the seated occupant 14. That is, in general, the occupant 14 may compress the seat cushion by more than 60% while seated. Therefore, a simple valve alone that may close and shut off or seal the bladder 48 without an accompanying pump 74/blower is insufficient to maintain or increase a desired firmness of the bladder 48. Instead, when the pump 74 operates in blower mode to introduce air 66 to the cavity 58 and throughout the foam 72, the bladder 48 may transition to the inflated condition 50 and thereby maintain a desired firmness of the bladder 48 and seat 10. Similarly, the pump 74 operating in vacuum mode to remove air 66 from the bladder 48 and foam 72 may transition the bladder 48 to the deflated condition 52. Yet, the foam 72 disposed within the cavity 58 may prevent complete deflation of the bladder and provide support to the seated occupant 14.

Referring again to FIG. 1, in one embodiment, the comfort system 16 includes a plurality of bladders 48 disposed beneath or below the seat cushion 22 and seat back 24 and adjacent the seat frame 110. The foam 72 is disposed within the cavity 58 of each of the plurality of bladders 48 such that the foam 72 contacts the respective upper surface 62 of each of the plurality of bladders 48 when each of the plurality of bladders 48 is in the deflated condition 52. As set forth in more detail below, certain bladders 48 may act in concert with one another to provide at least one of massage, targeted lumbar support, targeted leg 34 support, targeted side support, and targeted upper back 32 support to the occupant 14.

Further, the comfort system 16 may include one or more pumps 74 each fluidly connected to a respective one of the plurality of bladders 48. The plurality of bladders 48 may be pneumatically connected to one another and to the one or more pumps 74 via conduits or hoses (not shown) so that air 66 may naturally flow between each bladder 48 throughout the comfort system 16. That is, the one or more pumps 74, regardless of whether configured to operate as a blower or a vacuum, may allow the free flow of air 66 within the comfort system 16 when the comfort system 16 is not engaged or occupied by the occupant 14 or an object 80 (FIG. 3).

For this embodiment, the comfort system 16 may also include a plurality of airflow meters 76 and a plurality of valves 78 such that each of the plurality of foam 72-filled bladders 48 is fluidly connected to a respective valve 78, pump 74, and airflow meter 76. As such, each of the plurality of bladders 48 may be individually controlled and actuated.

More specifically, as described with continued reference to FIG. 1, the plurality of bladders 48 may be disposed in a first symmetrical matrix 82 on the seat back 24 about the first longitudinal axis 26. The plurality of bladders 48 may be disposed in a second symmetrical matrix 84 on the seat cushion 22 about the second longitudinal axis 28. In addition, each of the plurality of bladders 48 may be transitionable between the inflated condition 50 (FIG. 3) and the deflated condition 52 (FIG. 3) such that each of the plurality of bladders 48 has a variable size and a variable firmness. That is, the foam 72-filled bladder 48 may be thicker or taller in the inflated condition 50 than in the deflated condition 52 as the upper surface 62 moves away from contacting or resting on the foam 72 and, depending on the initial firmness of the foam 72 before inflation, may be firmer in the inflated condition 50 than in the deflated condition 52. That is, if the initial firmness of the foam 72 is relatively soft and resilient, the inflated condition 50 may provide a comparatively firmer comfort level for the occupant 14. Conversely, if the initial firmness of the foam 72 is relatively firm and comparatively less resilient, the inflated condition 50 may provide a comparatively softer comfort level for the occupant 14.

In addition, each of the plurality of bladders 48 may be individually controlled and individually transitionable between the inflated condition 50 and the deflated condition 52. For example, under some operating conditions, the occupant 14 may desire that the bladders 48 disposed beneath the seat cushion 22 inflate while the bladders 48 disposed beneath the seat back 24 remain in the deflated condition 52. Alternatively, in other operating conditions, the occupant 14 may desire that the bladders disposed beneath the seat back 24 inflate while the bladders 48 disposed beneath the seat cushion 22 remain in the deflated condition 52.

As another non-limiting example, the occupant 14 may desire that the bladders 48 disposed near the third axis 30 (FIG. 1) on the seat back 24 inflate while other bladders 48 disposed beneath the seat back 24 remain in the deflated condition 52. In other circumstances, the occupant 14 may desire that the bladders 48 disposed on a right side 86 (FIG. 1) of the second longitudinal axis 28 inflate while other of the bladders 48 disposed on a left side 88 (FIG. 1) of the second longitudinal axis 28 to remain in the deflated condition 52.

As best shown in FIG. 1, the seat 10 may include more than one bladder 48 disposed beneath the seat cushion 22 and adjacent the seat frame 110 and more than one bladder 48 disposed beneath the seat back 24 and adjacent the seat frame 110. For example, the comfort system 16 and seat 10 may include from two to twenty bladders 48 disposed beneath the seat back 24 and from two to twenty bladders 48 disposed beneath the seat cushion 22. In one non-limiting example shown in FIG. 1, the comfort system 16 may include twelve bladders 48 disposed beneath the seat back 24 and ten bladders disposed beneath the seat cushion 22. It is noted that two of the twelve bladders 48 disposed beneath the seat back 24 may be disposed beneath a respective side bolster 42, 142 and adjacent the seat frame 110 and two of the ten bladders 48 disposed beneath the seat cushion 22 may be disposed beneath a respective leg bolster 46, 146 and adjacent the seat frame 110.

Advantageously, the plurality of bladders 48 and comfort system 16 may also provide massage functionality, lumbar support, bolster 42, 142, 46, 146 adjustability, and occupant 14 detection. For example, the comfort system 16 may enable massage functionality of the seat 10. That is, at least some of the plurality of bladders 48 may cyclically transition between the inflated condition 50 (FIG. 3) and the deflated condition 52 (FIG. 3) to thereby massage the occupant 14. Optionally, the bladder 48 may also be hyper-inflated or extended beyond a height of the foam 72 for exertion of extra force on the occupant 14 in a desired location.

Each of the plurality of bladders 48 filled with foam 72 may enable massage functionality while avoiding the use of an accordion structure that may experience dimensional distortion, be visible through a finish surface, and/or may not return to an initial flat position after use. It is noted that use of the bladders 48 to massage the occupant 14 may negate a concurrent use of the variable firmness and variable size features set forth above.

Additionally or alternatively, the plurality of bladders 48 and comfort system 16 may provide lumbar support to the occupant 14. That is, as described with reference to FIG. 1, two of the plurality of bladders 48 disposed beneath the seat back 24 may be disposed on opposite sides 186, 188 of the first longitudinal axis 26, may be disposed adjacent the third axis 30, and may be configured to inflate, i.e., transition from the deflated condition 52 (FIG. 3) to the inflated condition 50 (FIG. 3), to thereby provide lumbar support to the occupant 14. For example, the plurality of bladders 48 may have a varied inflation/deflation pattern or cycle such that two or more of the plurality of bladders 48 may inflate at the same time to support a lumbar region of the occupant 14 on the seat 10.

Alternatively, two or more of the plurality of bladders 48 may inflate and deflate at regular intervals. For example, two or more of the plurality of bladders 48 may transition to the inflated condition 50 to protrude toward the lumbar region of the occupant 14 for a fixed time period, e.g., two minutes, and then transition to the deflated condition 52 to recede away from the lumbar region of the occupant 14 for the same or a different fixed time period, e.g., two minutes or three minutes, before again transitioning to the inflated condition 50 for the fixed time period. Such lumbar support may be controlled at a direction of the occupant 14.

Alternatively or additionally, the comfort system 16 may provide Lordosis, i.e., excessive inward curvature of the spine, relief to the occupant 14. That is, the two bladders 48 specifically designated for lumbar relief as set forth above may also cyclically transition between the inflated condition 50 and the deflated condition 52 to thereby massage the occupant 14.

Alternatively or additionally, the comfort system 16 may enable upper back 32 support for the occupant 14. That is, referring again to FIG. 1, two of the plurality of bladders 48 disposed beneath the seat back 24 may be disposed on opposite sides 186, 188 of the first longitudinal axis 26, may be spaced apart from the third axis 30, and may be configured to inflate to thereby provide upper back 32 support to the occupant 14. That is, an uppermost set of bladders 48 may transition from the deflated condition 52 (FIG. 3) to the inflated condition 50 (FIG. 3) to thereby protrude towards an upper spine of the occupant 14 and thereby support the upper back 32 of the occupant 14 against the seat back 24. Such upper back 32 support may also enable using the seat 10 in a fully reclined lounge position, or as a zero-gravity seat 10. In other non-limiting examples, the two uppermost bladders 48 may cyclically and repeatedly transition between the inflated condition 50 and the deflated condition 52 to thereby massage the upper back 32 of the occupant 14.

Alternatively or additionally, and as again described with reference to FIG. 1, for embodiments which include the two side bolsters 42, 142 each disposed on opposite sides 186, 188 of the first longitudinal axis 26, at least one of the plurality of bladders 48 may be disposed between one of the two side bolsters 42, 142 and the first longitudinal axis 26, and each of another two of the plurality of bladders 48 may be disposed beneath a respective one of the two side bolsters 42, 142 adjacent the seat frame 110 and may be transitionable between the inflated condition 50 (FIG. 3) and the deflated condition 52 (FIG. 3) to thereby adjust the comfort and size of the two side bolsters 42, 142. That is, one of the bladders 48 may be located beneath each respective side bolster 42, 142 and may allow the occupant 14 to adjust a dimension and/or firmness of each side bolster 42, 142. Therefore, the occupant 14 may enlarge the seat 10 by deflating one or more bladders 48 associated with the side bolters 42, 142 and/or may confine the available seating area by inflating one or more bladders 48 associated with the side bolsters 42, 142.

Alternatively or additionally, and as again described with reference to FIG. 1, for embodiments which include the two leg bolsters 46, 146 each disposed on opposite sides 86, 88 of the second longitudinal axis 28, at least one of the plurality of bladders 48 may be disposed between one of the two leg bolsters 46, 146 and the second longitudinal axis 28, and each of another two of the plurality of bladders 48 may be disposed beneath a respective one of the two leg bolsters 46, 146 adjacent the seat frame 110 and may be transitionable between the inflated condition 50 (FIG. 3) and the deflated condition 52 (FIG. 3) to thereby adjust the comfort and size of the two leg bolsters 46, 146. That is, one of the bladders 48 may be located beneath each respective leg bolster 46, 146 and may allow the occupant 14 to adjust a dimension and/or firmness of each leg bolster 46, 146. Therefore, the occupant 14 may enlarge the seat 10 by deflating one or more bladders 48 associated with the leg bolters 46, 146 and/or may confine the available seating area by inflating one or more bladders 48 associated with the leg bolsters 46, 146.

Alternatively or additionally, and as described with reference to FIG. 2, the comfort system 16 may provide for occupant 14 or object 80 detection. That is, the plurality of bladders 48 disposed underneath or beneath or below the seat cushion 22 may be configured to detect at least one of the occupant 14 and the object 80, such as a package, a container, a child seat, and the like, disposed on the comfort system 16 based on a pressure pattern exerted on the comfort system 16. For example, the comfort system 16 may be arranged to monitor and report a pressure differential across one or more of the bladders 48 closed to airflow or a rate of airflow to the one or more pumps 74 for one or more bladders that are open to natural airflow. As such, the plurality of bladders 48 each filled with foam 72 may not require the use of liquid or electronics to determine pressure changes.

In another non-limiting example, the comfort system 16 may include a pressure sensor 90 (FIG. 3) disposed within the cavity 58 of at least one of the plurality of bladders 48 and configured to detect a pressure exerted by the at least one of the occupant 14 and the object 80 on the comfort system 16. Further, the comfort system 16 may allow for detecting 108 (FIG. 4) a shape or size of the occupant 14 or object 80 disposed on the seat 10 based on the pressure pattern, so as to differentiate between a package, child seat, adult, and child, for example. Such occupant 14 and object 80 detection may be coupled with, for example, seat belt reminders and/or airbag deployment systems of the motor vehicle 18 (FIG. 2).

As such, in one specific embodiment shown generally in FIG. 1, the comfort system 16 may combine massage functionality, lumbar support, bolster 42, 142, 46, 146 adjustability, and occupant 14/object 80 detection while providing size and comfort adjustability. That is, at least some of the plurality of bladders 48 may cyclically transition between the inflated condition 50 and the deflated condition 52 to massage the occupant 14. Two of the plurality of bladders 48 disposed beneath the seat back 24 may be disposed on opposite sides 186, 188 of the first longitudinal axis 26 between the two side bolsters 42, 142 at the lower end 38 and may be configured to inflate to provide lumbar support to the occupant 14. Two of the plurality of bladders 48 disposed beneath the seat back 24 may each be disposed beneath a respective one of the two side bolsters 42, 142 and adjacent the seat frame 110 and may be configured to adjust the dimension and firmness of the two side bolsters 42, 142. Similarly, two of the plurality of bladders 48 disposed beneath the seat cushion 22 may each be disposed beneath a respective one of the two leg bolsters 46, 146 and adjacent the seat frame 110 and may be configured to adjust the dimension and firmness of the two leg bolsters 46, 146. Further, at least some of the plurality of bladders 48 disposed beneath the seat cushion 22 may be configured to detect at least one of the occupant 14 and the object 80 disposed on the comfort system 16.

Advantageously, the plurality of bladders 48 and comfort system 16 may also provide massage functionality, lumbar support, bolster 42, 142, 46, 146 adjustability, occupant 14 detection, and adjustable firmness and dimension without the need for redundant systems and components and bulky layers of padding and cushioning. That is, the comfort system 16 allows for seats 10 having adjustable dimensions and comfort and allows for increased cushioning when desired by the occupant 14, while enabling a comparatively thinner and simpler seat 10. The seat 10 including the comfort system 16 is simple and allows for firmness and dimensional selectivity without multiple singular-function components that take up space within the seat 10.

Referring now to FIG. 4, the method 12 of adjusting the size and comfort of the seat 10 includes regulating 92 air 66 (FIG. 3) contained within the comfort system 16 (FIG. 1) disposed between the seat frame 110 of the seat 10 and the seating surface 20 supported by the seat frame 110. For example, regulating 92 may include opening the valve 78 (FIG. 3) to allow airflow to the cavity 58 and partially or fully closing the valve 78 to restrict airflow to the cavity 58. Similarly, regulating 92 the air 66 contained within the foam 72-filled bladder 48 of the comfort system 16 may include allowing natural airflow through the opening 64 (FIG. 3) defined by the bladder 48 that is restricted solely by the pneumatics of the foam 72, or inflating and deflating the bladder 48 and foam 72 with the pump 74, e.g., while operating in blower or vacuum mode.

The method 12 further includes removing 94 air from the cavity 58 and the foam 72 to transition the bladder 48 to the deflated condition 52 (FIG. 3) such that the foam 72 contacts the upper surface 62 (FIG. 3) of the bladder 48 to thereby increase the size of the seat 10. That is, the one or more pumps 74 may be configured as the vacuum to remove the air 66 from the cavity 58 and foam 72.

The method 12 also includes introducing 96 the air 66 into the cavity 58 and throughout the foam 72 to transition the bladder 48 to the inflated condition 50 (FIG. 3) to thereby decrease the size of the seat 10. That is, the one or more pumps 74 may be configured as the blower to push air 66 into the cavity 58 and foam 72, increase a dimension of the comfort system 16, and thereby decrease an area of the seat 10 available for the occupant 14.

The method 12 further includes opening 98 the bladder 48 to airflow to thereby decrease the firmness and adjust the comfort of the seat 10, and closing 100 the bladder 48 to airflow to thereby increase the firmness and adjust the comfort of the seat 10. That is, opening 98 may include allowing natural airflow within the comfort system 16 such that the firmness and comfort are equivalent to a firmness and comfort of the foam 72. Closing 100 may include preventing natural airflow within the comfort system 16, for example, by restricting airflow with the valve 78, such that the bladder 48 inflates and the firmness and comfort are equivalent to a firmness and comfort of the inflated bladders 48 and contained air 66 within the comfort system 16.

As set forth above, the method 12 may also include at least one of massaging 102 the occupant 14 by cyclically inflating and deflating the bladder 48; providing 104 lumbar support to the occupant 14 by inflating the bladder 48; customizing 106 at least one of two side bolsters 42, 142 and two leg bolsters 46, 146 of the seat 10 by inflating or deflating the bladder 48; and detecting 108 at least one of the occupant 14 and the object 80 disposed on the seat 10 by sensing a pressure exerted on the bladder 48.

Therefore, in summary, the seat 10, comfort system 16, and method 12 may be useful for adjusting a dimension, firmness, and comfort level of a vehicular seat 10 based on a shape, size, and/or preference of an occupant 14 of the seat 10. Further, the comfort system 16 may provide adjustable firmness seat padding via contained air regulation, and the seat 10 and method 12 may provide massage, lumbar support, bolster adjustability, and occupant detection functionality.

The described embodiments of the present disclosure are intended to serve as non-limiting examples, and other embodiments may take various and alternative forms. In addition, the appended drawings are not necessarily to scale, and may present a somewhat simplified representation of various features of the present disclosure, including, for example, specific dimensions, orientations, locations, and shapes. Details associated with such features will be determined in part by the intended application and use environment of the described embodiments.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function. In addition, the use of ordinals such as first, second and third does not necessarily imply a ranked sense of order, but rather may only distinguish between multiple instances of an act or structure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A seat comprising:
a seat frame;
a seating surface supported by the seat frame; and
a comfort system disposed between the seat frame and the seating surface and including:
a bladder transitionable between an inflated condition and a deflated condition such that the bladder has a variable size and a variable firmness;
wherein the bladder defines a cavity and includes:
a lower surface disposed adjacent the seat frame; and
an upper surface opposite the lower surface and configured to support an occupant of the seat;
a foam disposed within the cavity, wherein the foam contacts the upper surface when the bladder is in the deflated condition; and
a pump configured for alternately introducing air into the cavity and throughout the foam and removing air from the cavity and the foam to transition the bladder between the inflated condition and the deflated condition.

2. The seat of claim 1, wherein the bladder has a first firmness when the cavity is open to airflow and has a second firmness that is greater than the first firmness when the cavity is closed to airflow.

3. The seat of claim 1, wherein the bladder has a first size when the bladder is in the deflated condition; and
wherein the bladder has a second size that is greater than the first size when the bladder is in the inflated condition.

4. The seat of claim 1, wherein the bladder further defines an opening therein configured for introducing air to and releasing air from the cavity.

5. The seat of claim 4, wherein the comfort system further includes an airflow meter disposed between the bladder and the pump and configured for measuring a flowrate of air between the pump and the cavity.

6. The seat of claim 5, wherein the comfort system further includes a valve disposed between the airflow meter and the pump and configured for restricting airflow between the pump and the cavity.

7. The seat of claim 1, wherein the seating surface includes a seat cushion having a first longitudinal axis and a seat back attached to the seat cushion and having a second longitudinal axis laterally aligned with the first longitudinal axis along a third axis that intersects the first longitudinal axis and the second longitudinal axis;
wherein the seat back is pivotable about the third axis and is configured to support a back of the occupant;
wherein the comfort system includes a plurality of bladders disposed beneath the seat cushion and the seat back and adjacent the seat frame; and
wherein each of the plurality of bladders is individually controlled and individually transitionable between the inflated condition and the deflated condition.

8. The seat of claim 7, wherein at least some of the plurality of bladders cyclically transition between the inflated condition and the deflated condition to thereby massage the occupant.

9. The seat of claim 7, wherein two of the plurality of bladders disposed beneath the seat back are disposed on opposite sides of the first longitudinal axis, are disposed adjacent the third axis, and are configured to inflate to thereby provide lumbar support to the occupant.

10. The seat of claim 9, wherein each of the two of the plurality of bladders cyclically transition between the inflated condition and the deflated condition to thereby massage the occupant.

11. The seat of claim 7, wherein two of the plurality of bladders disposed beneath the seat back are disposed on opposite sides of the first longitudinal axis, are spaced apart from the third axis, and are configured to inflate to thereby provide upper back support to the occupant.

12. The seat of claim 7,
wherein the seat back further includes two side bolsters each disposed on opposite sides of the first longitudinal axis;
wherein at least one of the plurality of bladders is disposed between one of the two side bolsters and the first longitudinal axis; and
wherein each of another two of the plurality of bladders is disposed beneath a respective one of the two side bolsters adjacent the seat frame and is transitionable between the inflated condition and the deflated condition to thereby adjust a comfort and size of the two side bolsters.

13. The seat of claim 7,
wherein the seat cushion further includes two leg bolsters each disposed on opposite sides of the second longitudinal axis;
wherein at least one of the plurality of bladders is disposed between one of the two leg bolsters and the second longitudinal axis; and
wherein each of another two of the plurality of bladders is disposed beneath a respective one of the two leg bolsters adjacent the seat frame and is transitionable between the inflated condition and the deflated condition to thereby adjust a comfort and size of the two leg bolsters.

14. The seat of claim 7, wherein the plurality of bladders disposed beneath the seat cushion are configured to detect at least one of the occupant and an object disposed on the comfort system.

15. The seat of claim 14, further including a pressure sensor disposed within the cavity of at least one of the plurality of bladders and configured to detect a pressure exerted by the at least one of the occupant and the object on the comfort system. 16 The seat of claim 1, wherein the foam is an open-cell flexible polyurethane foam and the bladder is formed from an elastomeric thermoplastic polyurethane.

17. A motor vehicle including the seat of claim 1.

18. A seat comprising:
a seat frame;
a seating surface supported by the seat frame;
wherein the seating surface includes a seat cushion having a first longitudinal axis and a seat back attached to the seat cushion and having a second longitudinal axis laterally aligned with the first longitudinal axis along a third axis that intersects the first longitudinal axis and the second longitudinal axis; and
wherein the seat back is pivotable about the third axis and includes two peripheral edges spaced apart from one another across the first longitudinal axis, a lower end adjacent the third axis, and an upper end spaced apart from the lower end along the first longitudinal axis;
wherein the seat back includes two side bolsters each disposed along a respective one of the two peripheral edges;
wherein the seat cushion includes two lateral edges spaced apart from one another across the second longitudinal axis and two leg bolsters each disposed along a respective one of the two lateral edges; and
a comfort system disposed between the seat frame and the seating surface and including:
a plurality of bladders disposed in a first symmetrical matrix beneath the seat back about the first longitudinal axis and adjacent the seat frame, disposed in a second symmetrical matrix beneath the seat cushion about the second longitudinal axis and adjacent the seat frame, and each transitionable between an inflated condition and a deflated condition such that each of the plurality of bladders has a variable size and a variable firmness;
wherein each of the plurality of bladders defines a cavity and includes:
a lower surface disposed adjacent the seat frame; and
an upper surface opposite the lower surface and configured to support an occupant of the seat;
a foam disposed within the cavity of each of the plurality of bladders, wherein the foam contacts the respective upper surface of each of the plurality of bladders when each of the plurality of bladders is in the deflated condition;
a pump configured for alternately introducing air into the cavity of each of the plurality of bladders and throughout the foam and removing air from the cavity of each of the plurality of bladders and the foam to transition each of the plurality of bladders between the inflated condition and the deflated condition;
an airflow meter configured for measuring a flowrate of air between the pump and the foam; and
a valve configured for restricting airflow between the pump and the foam;
wherein at least some of the plurality of bladders cyclically transition between the inflated condition and the deflated condition to massage the occupant;
wherein two of the plurality of bladders disposed beneath the seat back are disposed on opposite sides of the first longitudinal axis between the two side bolsters at the lower end and are configured to inflate to provide lumbar support to the occupant;
wherein two of the plurality of bladders disposed beneath the seat back are each disposed beneath a respective one of the two side bolsters adjacent the seat frame and are configured to adjust a dimension and firmness of the two side bolsters;
wherein two of the plurality of bladders disposed beneath the seat cushion are each disposed beneath a respective one of the two leg bolsters adjacent the seat frame and are configured to adjust a dimension and firmness of the two leg bolsters; and
wherein at least some of the plurality of bladders disposed beneath the seat cushion are configured to detect at least one of the occupant and an object disposed on the comfort system.

19. A method of adjusting a size and comfort of a seat, the method including:
regulating air contained within a comfort system disposed between a seat frame of the seat and a seating surface supported by the seat frame;
wherein the comfort system includes:
a bladder that is transitionable between an inflated condition and a deflated condition such that the bladder has a variable size and a variable firmness;
wherein the bladder defines a cavity and includes:
a lower surface disposed adjacent the seat frame; and
an upper surface opposite the lower surface and configured to support an occupant of the seat;
a foam disposed within the cavity, wherein the foam contacts the upper surface when the bladder is in the deflated condition; and
a pump configured for alternately introducing air into the cavity and throughout the foam and removing air from the cavity and the foam to transition the bladder between the inflated condition and the deflated condition;
removing air from the cavity and the foam to transition the bladder to the deflated condition such that the foam contacts the upper surface of the bladder to thereby increase the size of the seat;
introducing the air into the cavity and throughout the foam to transition the bladder to the inflated condition to thereby decrease the size of the seat;
opening the bladder to airflow to thereby decrease a firmness and adjust the comfort of the seat; and
closing the bladder to airflow to thereby increase the firmness and adjust the comfort of the seat.

20. The method of claim 19, further including at least one of:
massaging the occupant by cyclically inflating and deflating the bladder;
providing lumbar support to the occupant by inflating the bladder;
customizing at least one of two side bolsters and two leg bolsters of the seat by inflating or deflating the bladder; and
detecting at least one of the occupant and an object disposed on the seat by sensing a pressure exerted on the bladder.
